(19) United States
(12) Patent Application Publication
(10) Pub. No.: US 2011/0186687 A1
(43) Pub. Date: Aug. 4, 2011

(54) UNMANNED GYROKITE AS SELF-POWERED AIRBORNE PLATFORM FOR ELECTRONIC SYSTEMS

(75) Inventor: Steven J. Elder, Tucson, AZ (US)

(73) Assignee: RAYTHEON COMPANY, Waltham, MA (US)

(21) Appl. No.: 12/696,389

(22) Filed: Jan. 29, 2010

(51) Int. Cl. B64C 31/06

(52) U.S. Cl. 244/155 A; 244/153 A

(57) ABSTRACT

Embodiments of an unmanned gyrokite for use in conjunction with a tether are provided. In one embodiment, the unmanned gyrokite includes an airframe configured to be attached to the tether, an autogyro rotor assembly mounted to the airframe and configured to generate lift when deployed in winds aloft, and a generator mechanically coupled to the autogyro rotor assembly and configured to be driven thereby. An electronic system coupled to the airframe is configured to be powered by the generator.

### TECHNICAL FIELD

The following disclosure relates generally to unmanned aerial vehicles and, more particularly, to embodiments of a self-powered, unmanned airborne platform or “gyrokite” suitable for supporting various types of electronic systems, such as aerial surveillance systems.

### BACKGROUND

The ability to provide continuous and sustainable intelligence, surveillance, and reconnaissance (commonly abbreviated as “ISR”) is highly valuable in both military and civilian applications. For example, in overseas military operations, the ability to conduct covert aerial surveillance of a designated geographical area has become increasingly useful for monitoring the movement of enemy combatants and for identifying potential threats, such as improvised explosive devices. Similarly, in the context of homeland security, the ability to maintain a widespread and continuous surveillance presence may help detect, and thereby discourage, the unauthorized transport of people and contraband across international borderlines. In the civilian sector, the ability to rapidly establish widespread monitoring of a geographical area can be critical after a large scale disaster, such as a hurricane, earthquake, or other natural disaster, to help support disaster relief efforts; e.g., to identify those in need of medical attention and/or to help coordinate search and rescue teams.

In recent years, Unmanned Aerial Vehicles (“UAVs”) have been increasingly employed to provide aerial ISR in military and certain civilian contexts. When utilized as a component of an Unmanned Aircraft System, UAVs enable real-time aerial observation of a designated geographical area without requiring the physical presence of a pilot or other human observer. The usage of UAVs thus helps to preserve the safety of aircrew and other personnel in the instances wherein the observed area is unsafe due to, for example, a hostile presence or environmental dangers. Furthermore, due to their airborne nature, UAVs are often able to monitor geographical areas that may be difficult to access by ground. As a still further advantage, UAVs equipped with specialized cameras can provide visual surveillance from a considerable distance thereby rendering visual detection of the UAV from an observed subject or subjects highly unlikely.

Although providing the above-noted advantages, UAVs are limited in certain respects. For example, Unmanned Aerial Vehicles, and more generally Unmanned Aircraft Systems, can be relatively costly to implement and maintain. In addition, the flight duration of an UAV is typically limited due, in part, to a current lack of inflight refueling capabilities. As a result, a single UAV generally cannot maintain a continuous, twenty-four hour ISR presence over a designated geographical area. Although a fleet of UAVs can be employed to provide such a continuous ISR presence, the maintenance, fueling, and overall operational costs of such UAV fleet are considerable.

There thus exists an ongoing need to provide embodiments of an unmanned aerial vehicle or other airborne platform capable of maintaining continuous and sustainable surveillance presence over a designated geographical area without refueling requirements. Ideally, embodiments of such an unmanned aerial vehicle or platform would be relatively inexpensive and straightforward to implement. It would also be desirable for such unmanned aerial vehicle or platform to be scalable and capable of being equipped with various types of mission-specific electronic systems to enable the vehicle to be adapted for both civilian and military uses including, for example, international border monitoring. Other desirable features and characteristics of the present invention will become apparent from the subsequent Detailed Description and the appended Claims, taken in conjunction with the accompanying Drawings and this Background.

### BRIEF SUMMARY

Embodiments of an unmanned gyrokite for use in conjunction with a tether are provided. In one embodiment, the unmanned gyrokite includes an airframe configured to be attached to the tether, an autogyro rotor assembly mounted to the airframe and configured to generate lift when deployed in winds aloft, and a generator mechanically coupled to the autogyro rotor assembly and configured to be driven thereby. An electronic system coupled to the airframe is configured to be powered by the generator.

### BRIEF DESCRIPTION OF THE DRAWINGS

At least one example of the present invention will hereinafter be described in conjunction with the following figures, wherein like numerals denote like elements, and:

FIG. 1 is an isometric view of an unmanned airborne platform or “gyrokite” in accordance with an exemplary embodiment; and

FIG. 2 is a functional block diagram generically illustrating a number of electrical components included within the exemplary gyrokite shown in FIG. 1.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. The following describes exemplary embodiments of an unmanned airborne platform that includes, among other structural elements, an autogyro rotor assembly and a tethered airframe. For ease of reference, and to emphasize the unique combination of an autogyro rotor assembly and tethered airframe, embodiments of the unmanned airborne platform are referred to below as an “unmanned gyrokite” or, more simply, as a “gyrokite.” The term “gyrokite,” therefore, is intended in a broad sense to encompass any aircraft or airborne platform having an autogyro rotor assembly and an airframe adapted to be attached, either directly or indirectly, to a tether.

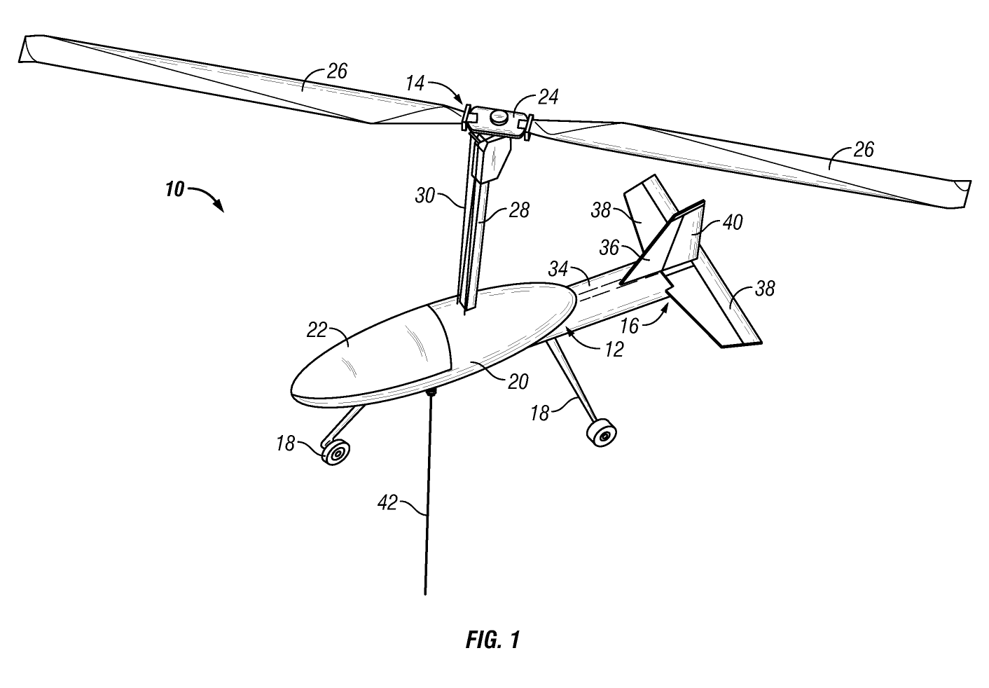

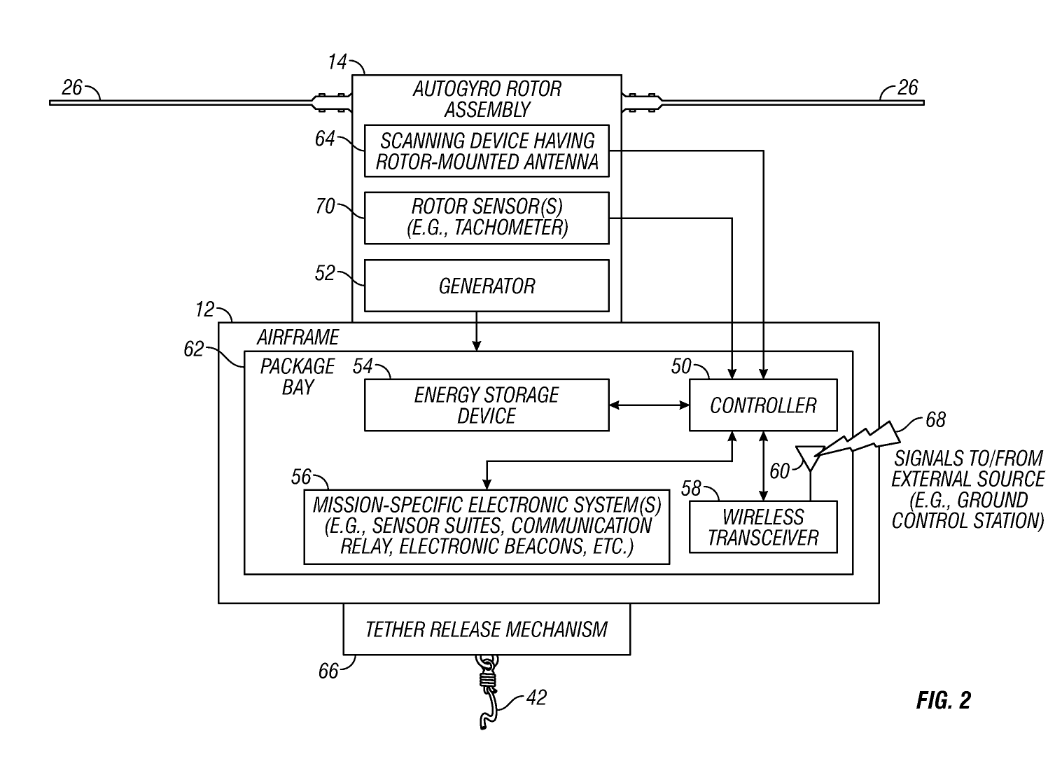

FIG. 1 is an isometric view of an unmanned airborne platform or “gyrokite” 10 in accordance with an exemplary embodiment. Gyrokite 10 includes an airframe 12, an autogyro rotor assembly 14, a tail assembly or empennage 16, and landing gear 18. In the illustrated example, landing gear 18 assumes the form of a plurality of non-retracted or fixed wheel assemblies; however, in alternative embodiments, gyrokite 10 may be equipped with various other types of landing gear (e.g., retractable wheel assemblies, pontoons, floats, landing skids, etc.) or may not include landing gear. An aerodynamic enclosure or nacelle 20 having a manually-removable cover 22 is affixed to a forward portion of airframe 12. Nacelle 20 encloses a package bay (hidden from view in FIG. 1), which may be accessed via removal of cover 22 and which may support one or more mission-specific electronic systems (e.g., sensor suites, repeaters, missile modules, etc.). A non-exhaustive list of the various types of mission-specific electronic systems that can be installed within the package bay of gyrokite 10 is set-forth below in conjunction with FIG. 2.

With reference to FIG. 1, autogyro rotor assembly 14 includes a rotor hub 24 and first and second rotor blades 26, which extend radially outward from rotor hub 24. Rotor hub 24 is rotatably mounted to the upper end of a vertical mast 28, the lower end of which is fixedly coupled (e.g., welded) to airframe 12. An elongated linkage 30 mechanically couple rotor hub 24 to at least one flight control surface actuator, which is housed within nacelle 20 and hidden from view in FIG. 1. During flight of gyrokite 10, the non-illustrated actuator tilts rotor rub 24 about two orthogonal axes to provide pitch and roll control in accordance with commands received from an onboard controller (e.g., controller 50 shown in FIG. 2 and described below) or an external control source, such as a Ground Control Station. In particular, rotor hub 24 can be titled in forward and aft directions to adjust the pitch of gyrokite 10, and rotor hub 24 can be tilted laterally or side-to-side to adjust the roll of gyrokite 10. This example notwithstanding, autogyro rotor assembly 14 may include various other flight control systems in alternative embodiments, which may adjust the position of the flight control surfaces of autogyro rotor assembly 14 in other manners. For example, in further embodiments, autogyro rotor assembly may include a swashplate assembly that adjusts the positioning of rotor blades 26 during flight. In still further embodiments, the pitch and/or roll of gyrokite 10 may be controlled, at least in part, by manipulating rotor-mounted flaps and/or by selectively rotating each rotor blade 26 about its longitudinal axis (commonly referred to as an “articulated rotor” configuration).

Rotor hub 24 and rotor blades 26 are free to rotate with respect to vertical mast 28. In contrast to the majority of rotary wing aircraft, rotor hub 24 is unpowered; that is, the rotation of rotor hub 24 is not driven by gas turbine engine or other onboard engine, at least during normal flight of gyrokite 10 (this is not to preclude the possibility that gyrokite 10 can be equipped with an auxiliary rotor drive system for assisted take-off purposes). Instead, when deployed in winds aloft, rotor hub 24 and rotor blades 26 autorotate and generate upward thrust and rotor torque. As air flows over and around rotor blades 26, the rotational rate of rotor blades 26 and rotor hub 24 increases until an equilibrium is reached between thrust and drag forces. When such an equilibrium is reached, rotor blades 26 and rotor hub 24 rotate at a substantially constant rotational speed and generate sufficient lift to maintain gyrokite 10 airborne. Notably, rotor blades 26 can be optimized to generate a considerable amount of upward thrust even when gyrokite 10 is deployed in moving air masses having low to moderate wind speeds. Consequently, by minimizing the weight of gyrokite 10 in an unloaded state (e.g., by forming airframe 12 from lightweight alloy or composite material), gyrokite 10 can be provided with relatively high weight-to-payload ratio can be achieved.

Rotor blades 26 may be formed from various rigid and semi-rigid materials. For example, rotor blades 26 can be formed from non-rigid materials to enable blades 26 to be folded or bent without structural damage. In embodiments wherein gyrokite 10 is relatively small in scale, this enables gyrokite 10 to be stored in a relatively compact container, such as a tubular canister, for physical protection and ease of transport. At the desired time of deployment, gyrokite 10 can be removed from the transport container and rotor blades 26 may unfurl, extend, or expand into the fully deployed position shown in FIG. 1. Rotor blades 26 may expand into the deployed position due to an inherent resiliency of the material or materials from which blades 26 are formed. Additionally or alternatively, rotor blades 26 may expand into the deployed position due to inflation by application of an external gas. As a specific example, rotor blades 26 may each have a parafoil construction; that is, each rotor blade 26 may comprise a non-rigid airfoil, which has an aerodynamic cellular structure that inflates when exposed to wind. In such a case, gyrokite 10 can be aerially deployed by, for example, airdrop from a larger manned or unmanned aircraft.

As indicated in FIG. 1, a tether 42 (partially shown) is fixedly coupled to at least one attachment point provided on gyrokite 10, such as a U-shaped projection provided on the underside of airframe 12. The lower end of tether 42 is anchored (or at least restrained) by attachment to a ballast weight or other ground-based object (not shown in FIG. 1 for clarity). During flight, tether 42 restrains the lateral and vertical movement of gyrokite 10 in opposition to autogyro rotor assembly 14 and, in so doing, enables gyrokite 10 to remain airborne over a desired geographical area without expenditure of fuel or an external power source. Gyrokite 10 can consequently maintain a continuous and self-sustained airborne presence over a desired geographical area for a near-indefinite period of time, which will typically be limited only by the operational lifespan of the components included within gyrokite 10.

Empennage 16 is fixedly coupled to the aft end portion of a tail boom 34 included within airframe 12. In the illustrated example, empennage 16 includes first and second horizontal stabilizers 38, a vertical stabilizer or fin 36, and a rudder 40, which is hingedly coupled to fin 36. During flight of gyrokite 10, the angular position of rudder 40 is adjusted by an actuator (not shown in FIG. 1) to control the yaw of gyrokite 10 in the well-known manner In further embodiments, one or more additional flight control surfaces, commonly referred to as “elevators,” may be hingedly coupled to horizontal stabilizers 38 to provide additional pitch control of gyrokite 10. Empennage 16 and autogyro rotor assembly 14 thus cooperate to control the major flight dynamic angles of gyrokite 10 during flight. As is the positioning of the flight control surfaces included in autogyro rotor assembly 14, the flight control surface of empennage 16 may be positioned in accordance with commands received from an onboard controller (e.g., controller 50 shown in FIG. 2 and described below) and/or with commands received from an external control source, such as a Ground Control Station.

FIG. 2 is a generalized block diagram illustrating, in part, the electrical infrastructure of exemplary gyrokite 10. The electrical components shown in FIG. 2, the manner in which the electrical components are interconnected, and the disposition of the illustrated electrical components are provided by way of example only; alternative embodiments of gyrokite 10 will inevitably include various other combinations and arrangements of electrical components. Furthermore, gyrokite 10 will typically include additional conventionally-known electrical components that are not shown in FIG. 1 for clarity; e.g., gyrokite 10 will typically include at least one flight control surface actuator for adjusting the tilt of autogyro rotor assembly 14 and/or the angular position of rudder 40 (FIG. 2) to control the pitch, roll, and yaw of gyrokite 10 in the above-described manner

In the exemplary embodiment illustrated in FIG. 2, gyrokite 10 includes a controller 50, a generator 52, an energy storage device 54, at least one mission-specific electronic system 56, and a wireless receiver 58 having an antenna 60. Controller 50 is operatively coupled to, and receives power from, energy storage device 54. In addition, controller 50 is operatively coupled to, and supplies output data to and/or receives input data from, mission specific electronic system 56 and wireless transceiver 58. Controller 50 may comprise, or be associated with, any suitable number of individual microprocessors, power supplies, storage devices, interface cards, auto flight systems, flight management computers, and other standard components known in the art. Furthermore, controller 50 may include or cooperate with any number of software programs (e.g., flight management programs) or instructions designed to carry out the various methods, process tasks, calculations, and control/display functions described below.

Generator 52 is mechanically coupled to autogyro rotor assembly 14 and is driven thereby during flight of gyrokite 10. Collectively, generator 52 and autogyro rotor assembly 14 function as a vertical axis wind turbine that supplies the electrical components of gyrokite 10 with an environmentally-friendly and virtually inexhaustible power source. As indicated in FIG. 2, generator 52 can be electrically coupled to a package bay 62, which supports one or more of energy storage device 54, controller 50, mission-specific electronic systems 56, and wireless transceiver 58. In one embodiment, package bay 62 is equipped with standardized electrical connectors and, possibly, universal mounting hardware (e.g., adjustable brackets or slides) to enable modular electrical components to be installed within and uninstalled from package bay 62, as desired. Due to the ability of gyrokite 10 to generate a lift and power without fuel consumption, the particular electronic components carried by package bay 62 will generally only be limited by size, weight, and power parameters of a particular embodiment of gyrokite 10. For this reason, and to emphasize the interchangeable nature of the components installed therein, package bay 62 will be referred to hereafter as “SWAP package bay 62.”

Energy storage device 54 provides a convenient source of auxiliary power if the electrical output of generator 52 should be temporarily insufficient to meet the electrical load placed on gyrokite 10 by the electrical components installed within SWAP package bay 62. Energy storage device 54 conveniently assumes the form of one or more super-capacitors or batteries that can be recharged by generator 52. As generically indicated in FIG. 2, generator 52 is conveniently housed within autogyro rotor assembly 14 and, specifically, within rotor hub 24 (FIG. 1).

Wireless transceiver 58 may assume any form suitable for enabling bi-directional communication with controller 50 including, for example, a C-band line-of-sight data link or a Kᵤ-band satellite data link. In embodiments wherein gyrokite 10 is not fully autonomous, wireless transceiver 58 may be configured to receive flight control instructions and other data from a Ground Control Station (“CGS”) or other external control source (as indicated in FIG. 2 at 68). In addition, during operation of gyrokite 10, transceiver 58 transmits data (e.g., one or more camera feeds) obtained from mission-specific electronic system 56 to a CGS or other external source. As conventionally known, various encryption algorithms can be employed to help maintain the integrity of the data transmitted to and received from gyrokite 10. In the exemplary embodiment illustrated in FIG. 2, wireless transceiver 58 is located onboard gyrokite 10 and, specifically, within SWAP package bay 62; however, in other embodiments, wireless transceiver 58 may be remotely located from gyrokite 10 (e.g., ground-based) and electrically coupled to controller 50 via an elongated cable. In such a case, the elongated connector electrically coupling controller 50 and transceiver 58 may be bundled with tether 42. Similarly, in certain embodiments, a power cable may be bundled with tether 42 and electrically couple SWAP package bay 62 to a ground-based power source, such as an auxiliary battery or battery pack, and/or to ground emplacements to which gyrokite 10 provides power. In embodiments wherein gyrokite 10 is fully autonomous, wireless transceiver 58 may be replaced by a transmitter.

Mission-specific electronic system 56 may include any number of electronic components, which may be selectively installed within SWAP package bay 62 based upon the desired mission capabilities of gyrokite 10. A non-exhaustive list of electronic components suitable for usage as or inclusion within mission-specific electronic system 56 includes various sensor suites, data transmission packages, telecommunication nodes, radar systems, direction finders, weapons systems, targeting systems, and the like. In many embodiments, such as when gyrokite 10 is utilized for international border monitoring or other surveillance functionalities, electronic system 56 will typically include at least one optical sensor, such as a daytime camera or an infrared or near-infrared camera for nighttime observation. When included within electronic system 56, the camera or cameras deployed aboard gyrokite 10 are conveniently nose- or belly-mounted. Alternatively or additionally, electronic system 56 may include one or more synthetic aperture radars capable of providing pseudo-photograph images in adverse weather conditions. When electronic system 56 includes multiple cameras, wireless transceiver 58 may be configured to simultaneously broadcast multiple real-time camera feeds to a CGS or other external control source, depending upon available bandwidth.

Mission-specific electronic system 56 may also include various other sensors in addition to, or in lieu of, the optical sensors set-forth above. For example, electronic system 56 may include one or more chemical sensors, such as a laser spectrometer for analyzing air samples and identifying airborne pathogens, toxic gases, and other biological weapons. When utilized for military applications, electronic system 56 may include a weapons system and/or a targeting system, such as a laser-designator module. Furthermore, whether utilized for military or civilian applications, electronic system 56 may include sensors for gathering weather data, such as various types of barometers, thermometers, hygrometer, and the like. Electronic system 56 may further include one or more sensors for monitoring operational parameters related to gyrokite 10, such as an altimeter, a gyroscope, an accelerometer, or the like. As a still further example, electronic system 56 may also include a multi-mode receiver having global navigational satellite system (e.g., Global Positioning System) capabilities.

In embodiment wherein gyrokite 10 is deployed over a geographical area lacking a working telecommunications infrastructure due to, for example, the occurrence of a hurricane, earthquake, or other natural disaster, gyrokite 10 may serve as an ad-hoc telecommunication node. In this case, mission-specific electronic system 56 may include or assume the form of a radio repeater, a cellular site, or other telecommunications relay. Similarly, in instances wherein gyrokite 10 is intended to be utilized for disaster relief, electronic system 56 may include an electronic beacon, such as a radio, infrared, or sonar beacon, to provide a reference point for the coordination of search and rescue teams or other on-the-ground personnel.

Gyrokite 10 can further be equipped with a scanning device that includes a rotor-mounted antenna or antennae 64 (generally referred to herein as “scanning device 64”). For example, as indicated in FIG. 2, scanning device 64 may be operatively coupled to controller 50, and the antenna or antenna of scanning device 64 may be integrated into (e.g., mounted to or embedded within) rotor blades 26 of autogyro rotor assembly 14. In this manner, scanning device 64 can utilize the autorotation of rotor blades 26 to conduct scanning sweeps. In many embodiments, scanning device 64 will assume the form of either a vertical scanning radar or a direction finder, such as an automatic radio direction finder. As further indicated in FIG. 2, gyrokite 10 may also include at least one rotor sensor 70 that is housed within autogyro rotor assembly 14 and operatively coupled to controller 50. When provided, rotor sensor 70 monitors at least one operational parameter of autogyro rotor assembly 14 (e.g., the angular positioning of rotor hub 24 and rotor blades 26); e.g., rotor sensor 70 may assume the form of a tachometer configured to monitor the rotational rate of rotor hub 24 (FIG. 1) and rotor blades 26. During operation, controller 50 utilizes the data provided by rotor sensor 70 to interpret the scan data provided by scanning device 64 and, possibly, to determine inflight adjustments to implement to rotor assembly 14.

In embodiments wherein gyrokite 10 may be fired upon or otherwise subject to attack, such as when gyrokite is utilized for monitoring an international borderline or hostile forces, gyrokite 10 may be configured to perform evasive movements on its tether in the event of attack. In addition, gyrokite 10 may be equipped with a tether release mechanism 66, which is operatively coupled to controller 50 and which is mechanically coupled between tether 42 and airframe 12. Should gyrokite 10 be threatened, controller 50 can actuate tether release mechanism 66 to disengage airframe 12 from tether 42 and thereby permit gyrokite 10 to glide away from the threat and to a nearby area of safety. Gyrokite 10 may also be equipped with various other defense mechanisms including, for example, various non-lethal immobilizing devices, such as blinding lights and/or sonic or ultrasonic sirens.

The foregoing has thus provided an exemplary embodiment of an unmanned gyrokite that serves as a self-powered airborne platform for various electronic systems. Advantageously, the production and maintenance costs associated with above-described exemplary gyrokite are low due, in part, to the gyrokite's ability to maintain a continuous airborne presence without requiring refueling. The above-described exemplary gyrokite is particularly well-suited for usage as an aerial surveillance platform to provide continuous monitoring of a designated geographical area, such as an international borderline. This notwithstanding, the exemplary gyrokite is highly scalable and can be equipped with various mission-specific modules to enable the gyrokite to perform a wide variety of civilian and military applications. Although the foregoing described the exemplary gyrokite as a single unit, it should be appreciated that an array of gyrokites can be deployed over a designated geographical area to optimize lift and power generation characteristics of the gyrokite fleet, as a whole. In such an array, the gyrokites may be coupled in series, in parallel, or both in series and in parallel by a multi-point tether system.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. An unmanned gyrokite for use in conjunction with a tether, the unmanned gyrokite comprising:
an airframe configured to be attached to the tether;
an autogyro rotor assembly mounted to the airframe and configured to generate lift when deployed in winds aloft;
a generator mechanically coupled to the autogyro rotor assembly and configured to be driven thereby; and
an electronic system coupled to the airframe and configured to be powered by the generator.

2. An unmanned gyrokite according to claim 1 wherein the autogyro rotor assembly comprises:
a rotor hub rotatably coupled to the airframe; and
a plurality of rotor blades extending radially outward from the rotor hub.

3. An unmanned gyrokite according to claim 2 wherein the generator is housed, at least partially, within the rotor hub.

4. An unmanned gyrokite according to claim 2 further comprising a scanning device having at least one antenna integrated into the autogyro rotor assembly.

5. An unmanned gyrokite according to claim 4 wherein the scanning device is selected from the group consisting of a vertical scanning radar and a direction finder.

6. An unmanned gyrokite according to claim 4 further comprising a rotor sensor coupled to the autogyro rotor assembly and configured to monitor an operational parameter thereof.

7. An unmanned gyrokite according to claim 6 wherein the rotor sensor comprises a tachometer configured to monitor the rotational speed of the rotor hub and plurality of rotor blades.

8. An unmanned gyrokite according to claim 2 wherein each of the plurality of rotor blades comprises a parafoil.

9. An unmanned gyrokite according to claim 1 further comprising:
a controller electrically coupled to the generator; and
a tether release mechanism mounted to the airframe and operatively coupled to the controller, the tether release mechanism configured to disengage the airframe and the tether when actuated by the controller.

10. An unmanned gyrokite according to claim 8 wherein the unmanned gyrokite is configured to be utilized in conjunction with a Ground Control Station, and wherein the unmanned gyrokite further comprises a wireless transceiver operatively coupled to the controller and configured to enable bi-directional communication between the controller and the Ground Control Station.

11. An unmanned gyrokite according to claim 1 wherein the electronic system comprises a camera.

12. An unmanned gyrokite according to claim 1 wherein the electronic system comprises a targeting system.

13. An unmanned gyrokite according to claim 1 wherein the electronic system comprises a telecommunication repeater.

14. An unmanned gyrokite according to claim 1 wherein the electronic system comprises a cellular site.

15. An unmanned gyrokite according to claim 1 wherein the electronic system comprises an electronic beacon.

16. An unmanned gyrokite for use in conjunction with a tether and an electronic system, the unmanned gyrokite comprising:
an airframe configured to be attached to the tether;
an autogyro rotor assembly mounted to the airframe and configured to generate lift when the unmanned gyrokite is deployed in winds aloft;
a package bay coupled to the airframe and to support the electronic system; and
a generator mechanically coupled to the autogyro rotor assembly and configured to be driven thereby, the generator supplying power to electronic system when installed within the package bay.

17. An unmanned gyrokite according to claim 16 further comprising:
a controller operatively coupled to the generator; and
a tether release mechanism operatively coupled the controller and mechanically coupled between the tether and the airframe, the tether release mechanism configuration to disengage the airframe from the tether when actuated by the controller.

18. An unmanned gyrokite according to claim 17 further comprising a scanning device operatively coupled to the controller and integrated into the autogyro rotor assembly.

19. An unmanned gyrokite for use in conjunction with a tether, the unmanned gyrokite comprising:
an airframe configured to be attached to the tether;
an autogyro rotor assembly mounted to the airframe and configured to generate lift when the unmanned gyrokite is deployed in winds aloft;
a generator mechanically coupled to the autogyro rotor assembly and configured to be driven thereby;
a surveillance sensor coupled to the airframe and configured to be powered by the generator; and
a transmitter operatively coupled to the surveillance sensor and configured to transmit data received therefrom.

20. An unmanned gyrokite according to claim 19 wherein the surveillance sensor is selected from the group consisting of a camera and a synthetic aperture radar.
